(19) United States
(12) Patent Application Publication
(10) Pub. No.: US 2014/0002353 A1
(43) Pub. Date: Jan. 2, 2014

(54) ADVANCED USER INTERACTION INTERFACE METHOD AND APPARATUS

(71) Applicants: Seong Yong Lim, Daejeon-si (KR); Ji Hun Cha, Daejeon-si (KR); In Jae Lee, Daejeon-si (KR); Sang Hyun Park, Daejeon-si (KR); Young Kwon Lim, Goyang-si Gyeonggi-do (KR)

(72) Inventors: Seong Yong Lim, Daejeon-si (KR); Ji Hun Cha, Daejeon-si (KR); In Jae Lee, Daejeon-si (KR); Sang Hyun Park, Daejeon-si (KR); Young Kwon Lim, Goyang-si Gyeonggi-do (KR)

(73) Assignee: Electronics and Telecommunications Research Institute, Daejeon (KR)

(21) Appl. No.: 14/005,492

(22) PCT Filed: Mar. 15, 2012
(86) PCT No.: PCT/KR2012/001889

§ 371 Date: Sep. 16, 2013

(30) Foreign Application Priority Data
Mar. 17, 2011 (KR) 10-2011-0023790
Jun. 8, 2011 (KR) 10-2011-0054881
Mar. 15, 2012 (KR) 10-2012-0026389

(51) Int. Cl. G06F 3/03

(52) U.S. Cl. CPC G06F 3/03
USPC 345/156

(57) ABSTRACT

The invention relates to an advanced user interaction (AUI) interface method, comprising a step of determining, from between a basic pattern type and a synthetic pattern type, the pattern type corresponding to physical information inputted from an object. The synthetic pattern type is a combination of at least two basic pattern types. The basic pattern type includes a geometric pattern type, a symbolic pattern type, a touch pattern type, a hand posture pattern type, and/or a hand gesture pattern type. The synthetic pattern type may include attribute information indicating whether the synthetic pattern type is one created by the same object. Thus, an advanced user interaction interface for advanced user interaction devices such as a multi-touch device and a motion-sensing remote controller may be provided.

### TECHNICAL FIELD

The present invention relates to an advanced user interaction (AUI) interface method and device.

### BACKGROUND ART

User interaction devices have been recently evolved. That is, in addition to devices for interaction with a user, such as an existing mouse, keyboard, touch pad, touch screen, speech recognition, and the like, a new type of user interaction devices such as a multi-touch pad, a motion sensing remote controller, and the like, have been recently introduced.

In order to provide an application technology for using the advanced user interaction devices, research into multimedia technologies has been conducted. However, most of the current user interaction standards have been concentrated on base interaction devices such as pointing or keying that are used in an existing electronic product.

That is, a user interaction standard for an advanced new type of user interaction devices such as the multi-touch pad, the motion sensing remote controller, and the like, as described above has not been present. In addition, a user interaction standard capable of applying to both of the base interaction devices such as the existing pointing or keying and the advanced new type of user interaction devices has not also been present

### DISCLOSURE

### Technical Problem

The present invention provides a method and device for providing an advanced user interaction interface for an advanced new type of user interaction devices such as a multi-touch pad, a motion sensing remote controller, and the like.

The present invention also provides an advanced user interaction interface capable of applying to both of base interaction devices such as existing pointing or keying and an advanced new type of user interaction devices.

### Technical Solution

In an aspect, an advanced user interaction interface method is provided. The advanced user interaction interface method includes: determining a pattern type corresponding to a physical information inputted from an object in a basic pattern type and a composite pattern type, wherein the composite pattern type is a combination of at least two pattern types of the basic pattern type, and wherein the basic pattern type includes at least one of a geometric interactivity pattern type, a symbolic pattern type, a symbolic touch pattern type, a hand posture pattern type, and a hand gesture pattern type. The composite pattern type includes attribute information indicating whether or not it is created by the same object. The geometric interactivity pattern type represents the physical information inputted from the object as two-dimensional (2D) or three-dimensional (3D) position information to recognize the physical information as a 2D or 3D geometry, and provides a predetermined number of base geometries as base geometric patterns and combines the base geometric patterns with each other to represent the physical information of the object. In representing the base geometric pattern, static information stopped in view of a time is described in an element, and dynamic information in view of the time is added as an option to an attribute to separately represent the static information and the dynamic information. symbolic pattern type recognizes the physical information as a symbol based on a size and a position of the physical information. The symbolic touch pattern types recognizes the physical information as a symbolic touch pattern based on an input continuance time, the number of inputs, an input movement direction, and a rotation direction of the physical information. The hand posture pattern type recognizes operation information inputted from the object as a new hand posture based on an input user's hand posture or user's position. The hand gesture pattern type recognizes dynamic operation information inputted from the object as a hand gesture based on the operation information. The geometric interactivity pattern type includes at least one of additional information of a point type, a line type, a rectangle type, an arc type and a circle type respectively. The additional information of the point type includes a coordinate, the additional information of the line type includes at least one of a starting point coordinate, an ending point coordinate, a starting point timestamp, an average velocity, and a maximum acceleration, the additional information of the rectangle type includes at least one of coordinates of diagonally positioned two corners and a timestamp when four corners are recognized, the additional information of the arc type includes at least one of coordinates corresponding to one end and the other end of an arc, a coordinate corresponding to the center of the arc, and an angular velocity, an angular acceleration, and a timestamp for a starting point of the arc, and the additional information of the circle type includes at least one of a coordinate of the center of a circle and a size of a radius of the circle. At least one of the pattern type and the additional information is provided to an application and the application performs a command corresponding to operation information inputted from the object using at least one of the provided pattern type or additional information. The determining of the pattern type corresponding to the physical information inputted from the object in the basic pattern type and the composite pattern type includes: determining that one of the basic pattern type and the composite pattern type is a first pattern type; and determining that one specific pattern type corresponding to operation information, which is the physical information inputted from the object, among pattern types belonging to the basic pattern type and the composite pattern type is a second pattern type, wherein the second pattern type belongs to the determined first pattern type. The advanced user interaction interface method may further include receiving the physical information of the object.

In another aspect, an advanced user interaction interface method is provided. The advanced user interaction interface method includes: receiving operation information from a user; determining a pattern type corresponding to physical information inputted from an object in a basic pattern type and a composite pattern type; and determining whether the physical information is a composite pattern type created by the same object in the case in which the physical information corresponds to the composite pattern type.

In still another aspect, an advanced user interaction interface apparatus is provided. The advanced user interaction interface apparatus includes: a user interface unit providing information of a pattern type corresponding to physical information inputted from an object in a basic pattern type and a composite pattern type, wherein the composite pattern type is a combination of at least two pattern types of the basic pattern type, and wherein the basic pattern type includes at least one of a geometric interactivity pattern type, a symbolic pattern type, a touch pattern type, a hand posture pattern type, and a hand gesture pattern type. The composite pattern type includes attribute information indicating whether or not it is created by the same object. The user interface unit may include: an interpreter creating semantics corresponding to the basic pattern type and the composite pattern type; and an interface determining and transferring the pattern type corresponding to the physical information inputted from the object in the basic pattern type and the composite pattern type. The user interface unit further includes a converter receiving information from the interface to convert the physical information into information of the pattern type corresponding to the physical information. The advanced user interaction interface apparatus may further include: an input device recognizing physical information of a user; and a creator receiving the information of the pattern type to create indication information for performing a command corresponding to the physical information inputted from the object. The advanced user interaction interface apparatus may further include an operator receiving the indication information to perform the command corresponding to the physical information.

### Advantageous Effects

With a method and device for providing an advanced user interaction interface according to embodiments of the present invention, an advanced user interaction interface for an advanced new type of user interaction devices such as a multi-touch device, a motion sensing remote controller, and the like, may be provided.

In addition, a semantic interface required by a user for manipulating a screen and an object manipulating interaction technology utilizing a hand posture, or the like, are provided to both of base interaction devices such as existing pointing or keying and the advanced new type of user interaction devices, thereby making it possible to provide an advanced user interaction interface.

Further, in the case in which a user simultaneously or sequentially performs a plurality of operations to input a plurality of operation information, whether or not the operation information is input by the same object, for example, the same hand, the same finger, or the like, using a predetermined attribute information (sameObject) value is detected to variously recognize types of operation information input by the user and more variously utilize the operation information input by the user, thereby making it possible to provide a more advanced user interaction interface.

Moreover, a base geometry corresponding to the operation information in a basic pattern type is provided as basic geometric interactivity patterns, thereby making it possible to represent all inputs of the user using the base geometric interactivity patterns.

Furthermore, a symbolic pattern type corresponding to the operation information in the basic pattern type includes a position and a size of a symbol as one pattern, thereby making it possible to represent a symbol type.

### DESCRIPTION OF DRAWINGS

FIG. 1 schematically shows the entire structure of MPEG-U part 2.

FIG. 2 is a flow chart of an advanced user interaction interface method according to an embodiment of the present invention.

FIG. 3 shows a high-level view of a relationship between MPEG-U and MPEG-V.

### MODE FOR INVENTION

Since the present invention may be variously modified and have several embodiments, specific embodiments will be shown in the accompanying drawings and be described in detail.

However, it is to be understood that the present invention is not limited to the specific embodiments, but includes all modifications, equivalents, and substitutions included in the spirit and the scope of the present invention.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component and the ‘second’ component may also be similarly named the ‘first’ component, without departing from the scope of the present invention. A term ‘and/or’ includes a combination of a plurality of related described items or any one of the plurality of related described items.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening there between.

Terms used in the present specification are used only in order to describe specific embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, an object will be defined as the meaning that it includes a finger, a hand, a head, or other portions of a body of a user in the case of implementing an interaction interface with the user using base interaction devices such as existing pointing or keying and an advanced new type of user interaction input devices such as a multi-touch pad, a motion sensing remote controller, and the like, and also includes both of a physical unit (a touch pen, or the like) transferring an operation of the user with a physical contact or a physical unit providing an operation of the user without the physical contact, in addition to a portion of the body of the user.

Hereinafter, desired embodiments of the present invention will be described in more detail with reference to the accompanying drawings.

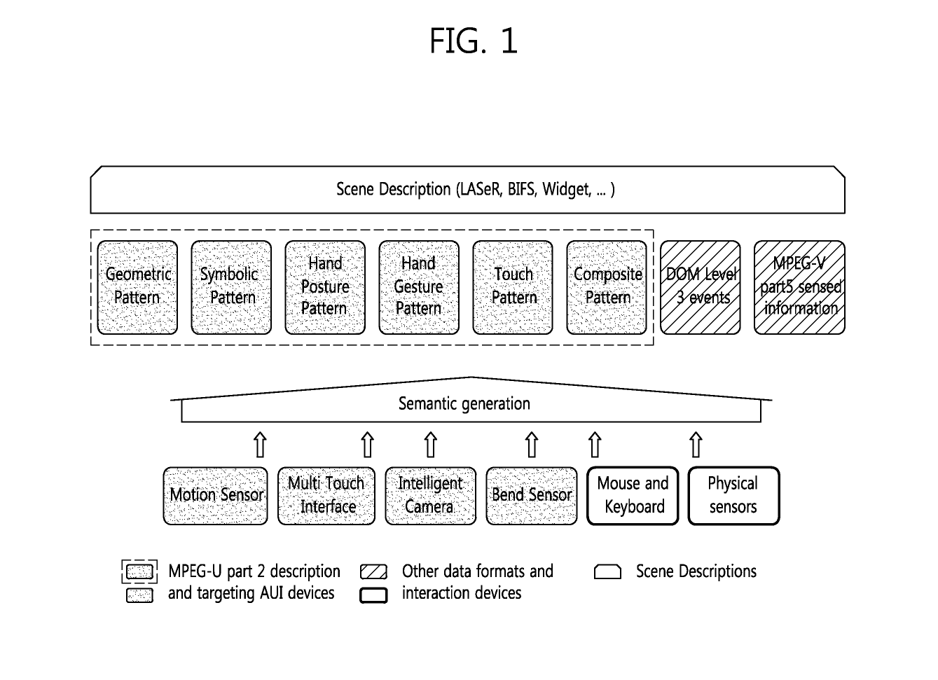

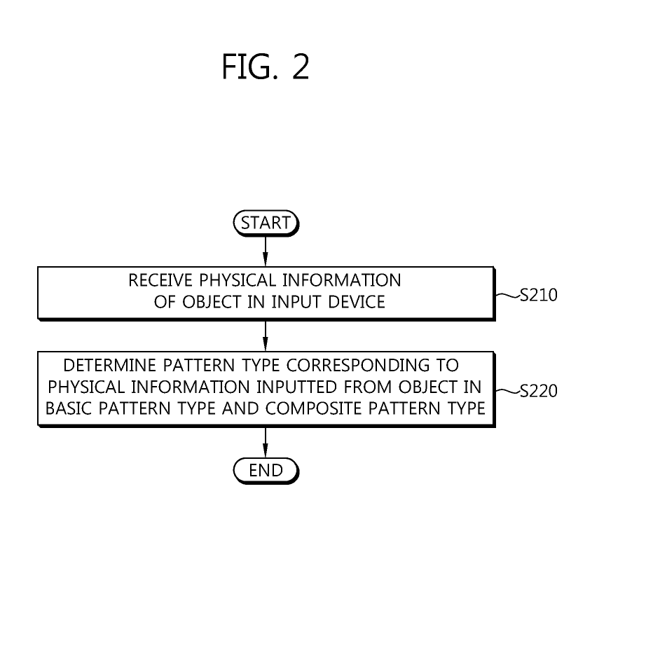

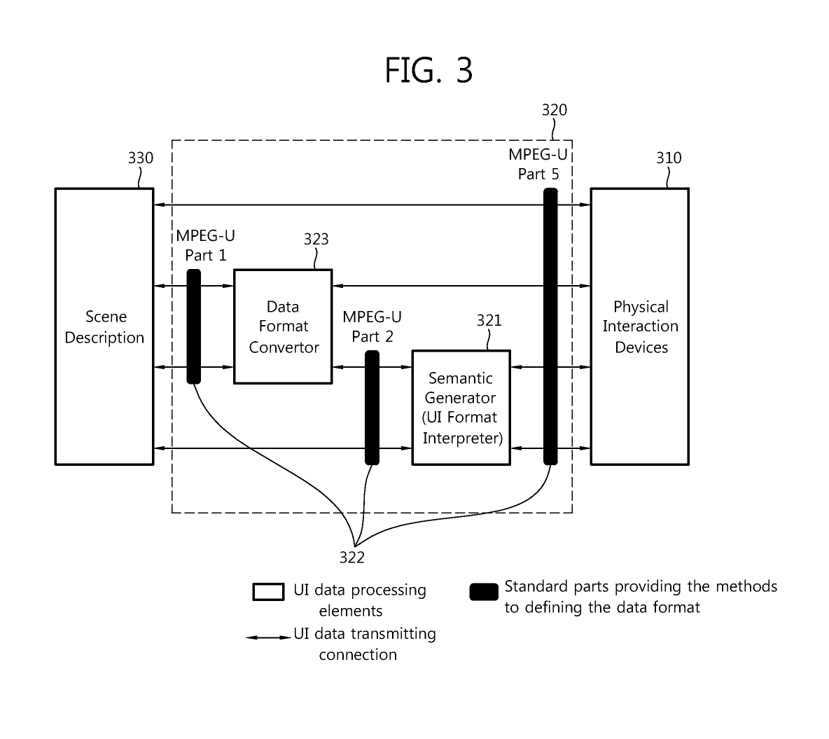

FIG. 1 schematically shows the entire structure of MPEG-U part 2; FIG. 2 shows a flow chart of an advanced user interaction interface method according to an embodiment of the present invention; and FIG. 3 shows a high-level view of a relationship between MPEG-U and MPEG-V.

The advanced user interaction interface method according to the embodiment of the present invention includes receiving physical information (for example, operation information) from a user (S210).

The user may input the operation information in a touch scheme of applying a physical contact to an input device or input the physical information (for example, the operation information) to the input device by taking a specific pose or making a gesture. The operation information may include operation information of a mouse, operation information through keying using a keyboard, operation information by an touch operation of the user, operation information by an operation or a gesture of the user, and any information representing an operation of the user transferred using any input device.

The input device may include a mouse, a keyboard, a touch pad, a touch screen, a touch sensor, or the like, capable of recognizing a physical contact of the user, or a mobile terminal, a television (TV), a monitor, or the like, in which a sensor capable of recognizing an operation, a pose, or the like, of the user without the physical contact is mounted. Here, the sensor capable of recognizing the operation, the pose, or the like, of the user may be a motion sensor or a camera.

After the operation information is received from the user, a pattern type corresponding to the operation information in a basic pattern type and a composite pattern type is determined (S220).

Referring to FIG. 1, an advanced user interaction interface device according to the embodiment of the present invention creates physical information from a user environment. This physical information may be recreated as meaningful information. For example, position information obtained from the finger of the user is collected, thereby making it possible to confirm information that a circle is drawn.

In the advanced user interaction interface method according to the exemplary embodiment of the present invention, a basic pattern type including this geometric interactivity pattern type, a symbolic pattern type, a symbolic touch pattern type, a hand posture pattern type, a hand gesture pattern type, or the like, and a composite pattern type formed of a combination thereof will be described.

Hereinafter, a common type used in the present invention will be defined. The common type, which is a common data type, includes a vector type configured of x, y, and z, a basic pattern type that becomes a base of another advance user interface (AUI) pattern, and a combination pattern type (or a composite pattern type) including another AUI pattern.

Syntax

<!-- ######################################################### -->

| | |
|---|---|
| <!-- Basic Datatype | --> |

```
<!-- ######################################################### -->
<complexType name=’VectorType’>
    <sequence>
        <element name=’X’ type=’float’/>
        <element name=’Y’ type=’float’/>
        <element name=’Z’ type=’float’ minOccurs=“0”/>
    </sequence>
</complexType>
<!-- ######################################################### -->
```

| | |
|---|---|
| <!-- AUI Base Datatype | --> |

<!-- ######################################################### -->
<complexType name=AUIBaseType>
<attribute name=capturedtimeStamp type=float default=“0 ” use =optional/>
</complexType>
<!-- ######################################################### -->

| | |
|---|---|
| <!-- Composite Pattern | --> |

```
<!-- ######################################################### -->
<complexType name=“CompositePatternType”>
    <sequence>
        <element name=“AUIPatternType” type=“aui:AUIBaseType manOccurs=“unbounded”/>
    </sequence>
    <attribute name=“sameObject” type=“boolean”/>
</complexType>
```

| Name | Definition |
|---|---|
| VectorType | This type describes the vector type composed of two float values and one |
| | optional value to represent a set of values. |
| X | A Value that describes a float value(can be force, torque, position) for x- |
| | axis |
| Y | A Value that describes a float value(can be force, torque, position) for y- |
| | axis |
| Z | A Value that describes a float value(can be force, torque; position) for z- |
| | axis |
| AUIBaseType | This type provides the topmost type of the base type hierarchy which each |
| | individual AUIdata formats can inherit |
| capturedTimeStamp | This attribute specifies the time (in milliseconds relative to the epoch) at |
| | which a user interaction was captured. When the value of |
| | capturedTimeStamp is not available, a value of 0 will be returned. |
| | Examples of epoch time are the time of the system start or 0:0.0 UTC 1st |
| | January 1970. |
| CompositePatternType | This type provides the container type as the placeholder for the set of AUI |
| | Patterns. Since users may generate more than one AUI patterns |
| | simultaneously, this type helps to transfer that set of patterns. |
| AUIPattern | This element specifies the AUI patterns that are simultaneously captured |
| | and transmitted. All patterns which inherit AUIBaseType can be contained. |
| sameObject | Add an attribute at the CompositePatternType to describe the relationship |
| | among the patterns in a composite pattern. If the value of “sameObject” |
| | attribute is true, all the patterns in a composite pattern are generated from |
| | same object and vice versa |

VectorType indicates a vector type configured by a combination of two float values and one selective value in order to indicate a set of values.

Each of x, y, and z indicates a float value of force, a torque, a position, or the like, in x, y, and z axes.

A basic pattern type (AUIBaseType) is a base type for receiving other AUI pattern types. capturedTimeStamp, which represents information on a time in which an AUI pattern is recognized, may be represented in a millisecond unit based on, for example, 0:0, Jan. 1, 1970. In the case in which a value of the recognized time information may not be represented, a value of 0 is returned.

A composite pattern type (CompositePatteryType) is a container type for containing another AUI pattern. Since a user may simultaneously represent several types of AUI patterns, the simultaneously represented AUI patterns are transferred in a composite pattern form using the composite pattern type.

AUIPatterns, which specify simultaneously recognized and transmitted AUI patterns, may include all patterns and elements inherited from the basic pattern type (AUIBaseType).

The sameObject is a feature (or an attribute) added to the composite pattern type. The specific meaning thereof will be described below.

The basic pattern type may include at least any one of a geometric interactivity pattern type, a symbolic pattern type, a touch pattern type, a hand posture pattern type, and a hand gesture pattern type.

First, the geometric interactivity pattern type will be described.

Generally, a user may perform various acts using his/her finger, hand, and body. High-level physical sensor devices may represent this geometric information as two-dimensional (2D) or three-dimensional (3D) Cartesian position information. However, position information is collected, such that the position information may be recognized as a new 2D or 3D geometry. Therefore, a base geometry corresponding to the operation information according to the embodiment of the present invention in a basic pattern type is provided as base geometric patterns, and the base geometric patterns are combined with each other, thereby making it possible to represent all inputs of the user.

The geometric interactivity pattern type includes at least any one of additional information of a point type, a line type, a rectangle type, an arc type, a circle type respectively.

Meaning and features of base geometric patterns included in the geometric interactivity pattern type are arranged and shown in the following Table.

| Name | Meaning | features |
|---|---|---|
| Point | A geometric point in 2D or 3D | Cartesian 2D or 3D position, (x, y) or (x, y, z). In |
| | Euclidean space | this part, all positions are described as Cartesian |
| | | 2D or 3D positions. |
| Line | A straight pattern between two points | Two positions at the two ends of a line with |
| | | optional values of starting timestamp velocity |
| | | and acceleration. |
| Rect | A crossed quadrilateral pattern with | Positions of two opposite corners and two |
| | four angles | optional corners with optional four timestamps to |
| | | represent when each corner was drawn |
| Arc | a curved segment pattern of the | Two positions for the starting and ending points |
| | circumference of a circle | of the circumference of a circle and the position |
| | | of the circle center point with optional values of |
| | | an angular velocity, an angular acceleration and |
| | | a starting timestamp. |
| Circle | A closed curve pattern which is | Position of the circle center point and the value of |
| | specified with a set of points which | the circle's radius |
| | have same distance from a center | |
| | point and which divides the plane into | |
| | two regions, an interior and an exterior. | |

```
<!-- ################################################ -->
<!-- Point Patterns  -->
<!-- ################################################ -->
<complexType name=“PointType”>
  <complexContent>
    <extension base=“aui:AUTBaseType”>
      </sequence>
        <element name=“Position” type=“aui:VectorType”/>
      </sequence>
    </extension>
  </complexContent>
</complexType>
<!-- ################################################ -->
<!-- Line Pattern  -->
<!-- ################################################ -->
<complexType name=“LineType”>
  <complexContent>
    <extension base=“aui:AUTBaseType”>
      <sequence>
        <element name=“FirstPosition” type=“aui:VectorType”/>
        <element name=“SecondPosition” type=“aui:VectorType”/>
      </sequence>
      <attribute name=“startingTimeStamp” type=“float” default=“0”
use=“optional”/>
      <attribute name=“averageVelocity” type=“float”default=“0”
use=“optional”/>
      <attribute name=“maxacceleration” type=“float”default=“0”
use =“optional”/>
    </extension>
  </complexContent>
</complexType>
<!-- ################################################ -->
<!-- Base Pattern  -->
<!-- ################################################ ->
<complexType name=“BaseType”>
  <complexContent>
    <extenstion base=“aui:AUIBaseType”>
      <sequence>
        <element name=“TopLeftPosition” type=“aui:VectorType”
minOccurs =“0”/>
        <element name=“BottomRightPostion” type=“aui:VectorType”
minOccurs =“0”/>
        <element name=“TopRightPosition” type=“aui:VectorType”
minOccurs =“0”/>
        <element name=“BottomLeftPosition” type=“aui:VectorType”
minOccurs =“0”>
      </sequence>
      <attribute name=“firstTimeStamp” default=“0” type=“float”
use=“optional”/>
      <attribute name=“secondTimeStamp” default=“0” type=“float”
use=“optional”/>
      <attribute name=“thirdTimeStamp” default”“0” type=“float”
use=“optional”/>
      <attribute name=“forthTimeStamp” default”“0” type=“float”
use=“optional”/>
    </extension>
  </complexContent>
</complexType>
<!-- ################################################ -->
<!-- Arc Pattern  -->
<!-- ################################################ -->
<complexType name=“ArcType”>
  <complexContent>
    <extension base=“aui:AUTBaseType”>
      <sequence>
        <element name=“FirstPosition” type=“aui:VectorType”/>
        <element name=“SecondPosition” type=“aui:VectorType”/>
        <element name=“CenterPosition” type=“aui:VectorType”/>
      </sequence>
      <attribute name=“startingTimeStamp” type=“float” default=“0”
use=“optional”/>
      <attribute name=“averageAngularVelocity” default=“0”
type=“float” use=“optional”/>
      <attribute name=“maxAngularAcceleration” default=“0”
type=“float” use=“optional”/>
    </extension>
  </complexContent>
</complexType>
<!-- ################################################ -->
<!-- Circle Pattern  -->
<!-- ################################################ -->
<complexType name=“CircleType”>
  <complexContent>
    <extension base=“aui:AUTBaseType”>
      <sequence>
        <element name=“CenterPosition” type=“aui:VectorType”/>
        <element name=“Radius” type=“float”/>
      <sequence/>
      <attribute name=“startingTimeStamp” type=“float” default=“0”
use=“optional”/>
      <attribute name=“averageAngularVelocity” type=“float”
default=“0” use=“optional”/>
      <attribute name=“maxAngularAcceleration” type=“float”
default=“0” use=“optional”/>
    </extension>
  </complexContent>
</complexType>
```

Referring to the syntax, in representing the base geometric pattern, static information stopped in view of a time is put in an element, and dynamic information in view of the time is added as an option to an attribute, thereby making it possible to separately represent the static information and the dynamic information in one element. For example, referring to a “line pattern” of the syntax, the static information stopped in view of the time, such as a first position (FirstPosition) and a second position (SecondPositioni) of a line, is described in the element, and the dynamic information in view of the time, such as a starting time stamp (startingTimeStamp)”, an “average velocity (avarageVelocity), a “maximum acceleration (maxAcceleration)” is added as an option to the attribute, thereby making it possible to separately represent the static information and the dynamic information.

| Name | Definition |
|---|---|
| PointType | This type describes a geometric point pattern in 2D or 3D Euclidean |
| | space. |
| Position | This element describes a Cartesian 2D or 3D position using VectorType |
| | (X, Y) or (X, Y, Z). ex: A position of a finger, a hand, head or even body. |
| LineType | This type describes a line pattern which consists of two end points. |
| FirstPosition | This element describes a Cartesian 2D or 3D position to represent the |
| | position of one end point in a line pattern. |
| SecondPosition | This element describes a Cartesian 2D or 3D position to represent the |
| | position of the other end point in a line pattern. |
| startingTimeStamp | This attribute describes timing information when drawing a line pattern |
| | was started |
| averageVelocity | This attribute describes the value of average velocity while creating a line |
| | pattern. |
| maxAcceleration | This attribute describes the value of maximum acceleration while creating |
| | a line pattern |
| RectType | This type describes a rectangular pattern which consists of four corner |
| | positions. A rectangular can be determined with at least two positions of a |
| | pair of opposite corners or four positions of rectangle's four corners. |
| TopLeftPosition | This element describes the position at the top-left corner of a rectangular |
| | pattern. |
| BottomRightPosition | This element describes the position at the bottom-right corner of a |
| | rectangular pattern at which the event occurred relative to the origin of the |
| | screen coordinate system. |
| TopRightPosition | This element describes the position at the top-right corner of a rectangular |
| | pattern. |
| BottomLeftPosition | This element describes the position at the bottom-left corner of a |
| | rectangular pattern. |
| firstTimeStamp | This attribute describes the timing information when drawing a rectangular |
| | pattern was started. It means this attribute represents when the first |
| | corner position was captured. |
| SecondTimeStamp | This attribute describes the timing information when the second corner |
| | was constructed and one line pattern was detected |
| thirdTimeStamp | This attribute describes the timing information when the third corner was |
| | constructed and connected two line patterns were detected |
| fourthTimeStamp | This attribute describes the timing information when the fourth corner was |
| | constructed and connected three line patterns were detected |
| ArcType | This type describes an arc pattern which is a segment of the |
| | circumference of a circle. |
| FirstPosition | This element describes the Cartesian 2D or 3D position of one end point |
| | in an arc pattern. |
| SecondPosition | This element describes the Cartesian 2D or 3D position of the other end |
| | point in an arc pattern. |
| CenterPosition | This element describes the Cartesian 2D or 3D position of a Circle center |
| | point in an arc pattern |
| startingTimeStamp | This attribute describes timing information when drawing an arc pattern |
| | was started. |
| averageAngularVelocity | This attribute describes the value of average angular velocity while |
| | creating an arc pattern. |
| maxAngularAcceleration | This attribute describes the value of maximum angular acceleration while |
| | creating an arc pattern |
| CircleType | This type describes a circle pattern |
| CenterPosition | The element describes the Cartesian 2D or 3D position of a circle center |
| | point in a circle pattern. |
| Radius | This element describes the radius of a circle pattern. |
| startingTimeStamp | This attribute describes timing information when drawing a circle pattern |
| | was started. |
| averageAngularVelocity | This attribute describes the value of average angular velocity while |
| | creating a circle pattern. |
| maxAngularAcceleration | The attribute describes the value of maximum angular acceleration while |
| | creating a circle pattern. |

In the geometric interactivity pattern type, a point type (PointType), which means a 2D or 3D geometric point in the Euclidean Space, includes 2D or 3D position information represented by a coordinate (x, y) or (x, y, z).

Position information (Position), which indicates a 2D or 3D position using a vector type represented by (x, y) or (x, y, z), includes information (Position) on a position of a finger, a hand, a head, a portion of a body, or the like.

A line type (LineType), which indicates a pattern of a straight line connecting two points to each other, includes positions information (FirstPosition and SecondPosition) on both end points of the straight line), starting time information (startingTimeStamp) of a selected straight line, velocity information (averageVelocity), and acceleration information (maxAcceleration).

The FirstPosition indicates a position of one ending point in a line pattern using 2D or 3D position information as a starting point coordinate, and the SecondPosition indicates a position of another ending point in the line pattern using 2D or 3D position information as an ending point coordinate.

The StartingTimeStamp is an attribute indicating time information on a time point in which a line pattern starts to be drawn as a starting point timestamp, the averageVelocity is an attribute indicating velocity information in the case in which average velocity information is obtained during formation of the line pattern, the maxAcceleration is an attribute indicating a maximum acceleration information during formation of the line pattern.

The Rect-type, which indicates a closed figure having four angles, is represented as position information of two corners of opposite sides or position information of four corners (TopLeftPosition, BottomRightPosition, TopRightPosition, and BottomLeftPosition) and includes time information (firstTimeStamp, secondTimeStamp, thirdTimeStamp, and fourthTimeStamp) for recognizing a time in which each corner is recognized.

The TopLeftPosition indicates position information of a top-left corner of the rectangle pattern, the TopRightPosition indicates position information of a top-right corner thereof, the BottomLeftPosition indicates position information of a bottom-left corner thereof, and the BottomRightPosition indicates position information of a bottom-right corner thereof. Here, the position information of the four corners of the rectangle pattern may be represented by coordinates of the four corners.

The firstTimeStamp to forthTimeStamp, which indicate information on a time in which each corner is recognized during formation of the rectangle pattern, may be represented by a time stamp when the four corners are recognized.

The Arc-type, which indicates an arc corresponding to a portion of a circle, include position information of a starting point and an ending point of the arc (FirstPosition and SecondPosition), position information of the center of the circle (CenterPosition), an angular velocity (averageAngularVelocy), an angular acceleration (maxAngularAcceleration), and information (startingTimeStamp) on a time in which an arc pattern starts to be drawn.

The FirstPosition indicates a position of one ending point of the arc pattern as 2D or 3D position information, and the SecondPosition indicates a position of another ending point of the arc pattern as 2D or 3D position information. The CenterPosition indicates the center of the circle of the arc pattern as 2D or 3D position information.

The StartingTimeStamp is an attribute indicating information on a time in which the arc pattern starts to be formed, and the averageAngularVelocy is an attribute indicating an average angular velocity during formation of the arc pattern. The maxAngularAcceleration indicates an average angular velocity during formation of the arc pattern. The position information on the starting point and the ending point of the arc may be represented by a coordinate corresponding to one end and the other end of the arc and a coordinate corresponding to the center of the arc, and the time information may be represented by an angular velocity, an angular acceleration, and a time stamp for the starting point of the arc.

The Circle-type, which is a set of points positioned at the same distance from one point and indicates a pattern dividing a space or a plane into the inside and the outside, includes position information of the center of the circle (CenterPosition) and size information of a radius of the circle (Radius).

The CenterPosition indicates a position of the center of the circle of the circle pattern as 2D or 3D position information, and the Radius indicates the size information of the radius of the circle pattern.

The startingTimeStamp is an attribute indicating information on a time in which the circle pattern starts to be formed, the averageAngularVelocity is an attribute indicating an average angular velocity during formation of the circle pattern, and the maxAngularAcceleration is an attribute indicating a maximum angular acceleration during formation of the circle pattern. It is useful to have a conversation through a simple gesture apart from saying or writing. For example, the known gesture such as O.K. or V sign has been utilized in various fields. The symbolic pattern type corresponding to the operation information according to the embodiment of the present invention in the basic pattern type includes a position and a size of a symbol as one pattern, thereby making it possible to represent a symbol type (symbolType).

This symbolic pattern type, which recognizes the operation information of the user as described above as a new symbol based on a size and a position of the operation information, provides a container pattern for containing the symbolic pattern.

Syntax

<!-- ################################################ -->

| | |
|---|---|
| <!-- Symbolic Pattern | --> |

```
<!-- ################################################ -->
<complexType name=“SymbolicPatternType”>
    <complexContent>
        <extension base=“aui:AUTBaseType”>
            <sequence>
                <element name=“Position” type=“aui:VectorType”/>
                <element name=“Size” type=“float”/>
            </sequence>
            <attribute name=“symbolType”
type=“mpeg7:termReferenceType” use=“optional”/>
        </extension>
    </complexContent>
</complexType>
```

Semantics

Semantics of the SymbolicPattern type:

| Name | Definition |
|---|---|
| SymbolicPatternType | This type describes a symbolic pattern container. |
| | ex. V sign, okay sign, heart sign |
| Position | This element describes the Cartesian 2D or 3D |
| | position to represent where a symbolic pattern |
| | was captured. |
| Size | This element describes the size value of a |
| | symbolic pattern. |
| symbolType | This attribute describes the label of a symbolic |
| | pattern as a reference to a classification scheme |
| | term provided by SymbolTypeCS. |

The SymbolicPatternType, which indicates a container for containing a symbolic pattern such as a V sign, an O.K. sign, or the like, includes elements of a position and a size.

A user interface device utilizing a touch technology has been widely commercialized, and various applications also have utilized this touch pattern.

The symbolic touch pattern type corresponding to the operation information according to the embodiment of the present invention in the basic pattern type may represent a basic touch, a position, and a required value according to a touch type.

The symbolic touch pattern type recognizes the operation information of the user as a new symbolic touch pattern based on an input continuance time, the number of inputs, an input movement direction, and a rotation direction of the operation information. Hereinafter, a container pattern for containing this known symbolic touch pattern is provided.

Syntax

<!-- ################################################ -->

| | |
|---|---|
| <!-- Symbolic Touch Pattern | --> |

```
<!-- ################################################ -->
<complexType name=“SymbolicTouchPatternType”>
    <complexContent>
        <extension base=“aui:AUTBaseType”>
            <sequence>
                <element name=“Position” type=“aui:VectorType”/>
            </sequence>
            <attribute name=“touchType”
type=“mpeg7:termReferenceType” use=“optional”/>
            <attribute name=“value” type=“float” use=“optional”/>
        </extension>
    </complexContent>
</complexType>
```

Semantics

Semantics of the SymbolicTouchPattern type:

| Name | Definition |
|---|---|
| SymbolicTouchPattern | This type describes a touch pattern container. |
| Type | ex. Tap, Double tap, Flick |
| Position | This element describes the Cartesian 2D or 3D |
| | position to represent where a symbolic touch |
| | pattern was captured. |
| touchType | This attribute describes the label of a symbolic |
| | touch pattern as a reference to a classification |
| | scheme term provided by TouchTypeCS. |
| value | This attribute describes the value that a touch |
| | pattern needs. It means that the meaning of this |
| | attribute is dependent on the symbolic touch |
| | pattern as described in 6.3.4 |

The SymbolicTouchPatternType, which indicates a container for containing a touch pattern such as tap, flick, or the like, includes an element of a position.

The Position represents a position information at which a symbolic touch pattern is recognized as 2D or 3D position information.

An intuitive pose of a hand is recognized, thereby making it possible to perform interaction For example, poses such as a pose of clenching a fist, a pose of spreading the palm, a pose of directing the thumb upwardly are widely used poses.

This hand posture pattern type recognizes the operation information as a new hand posture based on an input user's hand posture and user's position.

Syntax

| <!-- ################################################ --> | |
|---|---|
| <!-- Hand Posture Pattern | --> |

```
<!-- ################################################ -->
<complexType name=“HandPostureType”>
    <complexContent>
        <extension base=“aui:AUTBaseType”>
            <sequence>
                <element name=“Posture”
type=“aui:HandPostureBaseType” maxOccurs=“2”/>
            </sequence>
        </extension>
    </complexContent>
</complexType>
<complexType name=“HandPostureBaseType”>
    <sequence>
        <element name=“PostureType”
        type=“aui:HandPostureDataType”/>
        <element name=“Chirality”
        type=“aui:ChiralityType” minOccurs=“0”/>
        <element name=“Position”
        type=“aui:VectorType” minOccurs=“0”/>
    </sequence>
</complexType>
<!-- ################################################ -->
<!--  HandPostureDataType  -->
<!-- ################################################ -->
<simpleType name=“HandPostureDataType”>
    <restriction base=“mpeg7:termReferenceType”/>
</simpleType>
```

### Semantics

Semantics of the HandPosture type:

| Name [symbol] | Definition [symbol] |
|---|---|
| HandPostureType [symbol] | This type describes a posture event of user's |
| | hand. [symbol] |
| Posture [symbol] | This element describes a posture type of |
| | user's hand. [symbol] |
| HandPostureBaseType [symbol] | This type defines a base type for describing |
| | a hand posture. [symbol] |
| PostureType [symbol] | This element describes a posture of hand |
| | from a posture set enumerated in hand |
| | posture classification scheme. [symbol] |
| Chirality [symbol] | This element describes whether the hand of |
| | interest is a left hand or a right hand. [symbol] |
| Position [symbol] | This element describes a position of user's |
| | hand at which the event occurred relative to |
| | the origin of the screen coordinate |
| | system. [symbol] |

The hand posture pattern type describes a pose of the user's hand, and a posture is an element meaning a type of a pose of the user's hand.

The HandPostureBaseType describes a posture of the hand in a set of poses enumerated in a classification, the Chirality indicates whether the user's hand is a left hand or a right hand, and the Position includes position information of the user's hand.

Meanwhile, in accordance with rapid commercialization of the interaction device, various aspects of interaction devices have been widely used. As another example of the interaction interface, there is a recognition of a dynamic operation of the user. For example, a gesture of shaking a hand is transferred as the same meaning to all persons. The hand gesture pattern type recognizes the operation information as a new hand gesture based on the dynamic operation information of the user.

Syntax

| <!-- ################################################ --> | |
|---|---|
| <!-- Hand Gesture Information | --> |

```
<!-- ################################################ -->
<element name=“HandGesture” type=“aui:HandGestureType”/>
<complexType name=“HandGestureType”>
    <complexContent>
        <extension base=“aui:AUTBaseType”>
            <sequence>
                <element name=“Gesture”
type=“aui:HandGestureDataType” minOccurs =“0”/>
                <element name=“Chirality”
                type=“aui:ChiralityType” minOccurs=“0”/>
            </sequence>
        </extension >
    </complexContent>
</complexType>
<!-- ################################################ -->
<!--  Hand Gesture Data Type  -->
<!-- ################################################ -->
<simpleType name=“HandGestureDataType”>
    <restriction base=“mpeg7:termReferenceType”/>
</simpleType>
```

Semantics

Semantics of the SensedInfoBaseAttributes:

| Name [symbol] | Definition [symbol] |
|---|---|
| HandGestureType [symbol] | This type describes a gesture event of |
| | user's hand. [symbol] |
| Gesture [symbol] | This element describes the gesture type |
| | of user's hand. [symbol] |
| Chirality [symbol] | This element describes whether the |
| | hand of interest is a left hand or a |
| | right hand. [symbol] |
| HandGestureBaseDataType [symbol] | This type describes a gesture of user's |
| | hand from the gesture set enumerated in |
| | the classification scheme. [symbol] |

The HandGestureType, which means an operation of the user's hand, includes element of the Gesture and the Chirality. The Gesture means a gesture type of the hand, and the Chirality indicates whether the hand is a left hand or a right hand.

The HandGestureDataType describes an operation of the hand among a set of gestures enumerated in a classification.

The above-mentioned geometric interactivity pattern type, symbolic pattern type, symbolic touch pattern type, hand posture pattern type, and hand gesture pattern type are included in the basic pattern type. After the operation information of the user is input, which of a plurality of basic pattern types the operation information of the user corresponds to is determined

In the composite pattern type, at least two of the above-mentioned basic pattern types are combined with each other. For example, when the operation information of the user corresponds to both of the symbolic pattern type and the symbolic touch pattern type, the operation information belongs to the composite pattern type.

The composite pattern type includes attribute information (sameObject) indicating whether or not the operation information of the user is a composite pattern type created by the same object.

For example, in the case in which the user inputs V shaped touch information by performing a V shaped touch operation using his/her right hand and then inputs touch information of a circle shape by performing a touch operation of the circle shape using the same his/her right hand, the attribute information (sameObject) is represented as true. However, in the case in which the user inputs the V shaped touch information by performing the V shaped touch operation using his/her right hand and then inputs touch information of a circle shape by performing a touch operation of the circle shape using his/her left hand, the attribute information is represented as false.

Therefore, since the composite pattern type includes the attribute information (sameObject), when the user simultaneously or sequentially performs a plurality of operations, the attribute information (sameObject) is differently represented according to whether or not the operation information is input using the same object, for example, the same hand, the same finger, the same head, or the like, such that created information becomes different. That is, kinds of operation information of the user are more variously recognized due to the attribute information (sameObject), such that the way utilizing the operation information may be diversifying.

That is, the advanced user interaction interface method according to the embodiments of the present invention receives the operation information from the user and determines a pattern type corresponding to the received operation information in the basic pattern type and the composite pattern type to provide information corresponding to the determined pattern type. In the case in which the composite pattern type is formed of a plurality of pattern types, any one specific pattern type corresponding to the operation information is determined to provide information corresponding to the determined pattern type. Here, in the case in which the operation information corresponds to the composite pattern type, a true value or a false value is provided according to whether or not the operation information is created by the same object to provide different commands to applications according to whether or not the operation information is created by the same object, thereby making it possible to more variously recognize the operation information of the user according to whether or not the operation information is created by the same object.

As described above, in the advanced user interaction interface method according to the embodiment of the present invention, after the operation information is received from the user to determine the pattern type corresponding to the operation information in the basic pattern type and the composite pattern type, information on the pattern type is provided to an application and a command corresponding to the operation information is performed using the pattern type provided to the application. When the pattern type corresponding to the operation information is provided to the application, in the case in which the operation information corresponds to the geometric interactivity pattern type, additional information of the geometric interactivity pattern type may also be provided together with the pattern type to the application.

Alternatively, according to another embodiment of the present invention, when the pattern type of the operation information inputted from the user is determined, after first pattern types (the basic pattern type or the composite pattern type) corresponding to the operation information of the user in the basic pattern type and the composite pattern type are first determined, any one specific second pattern type corresponding to the operation information in the determined first pattern type (the basic pattern type or the composite pattern type) may be determined

The basic pattern type may include a plurality of pattern types including the geometric interactivity pattern type and the symbolic pattern type, and the composite pattern type may be formed of a combination of at least two basic pattern types. Therefore, basic pattern type and the composite pattern type may include a plurality of pattern types.

Therefore, when the pattern type corresponding to the operation information of the user is determined, which of the basic pattern type and the composite pattern type the operation information of the user corresponds to is first determined, thereby making it possible to determine the first pattern type. Then, in the case in which the input operation information corresponds to the basic pattern type, which of a plurality of pattern types configuring the basic pattern type the operation information specifically corresponds to is determined to determine the second pattern type. Alternatively, in the case in which the input operation information corresponds to the composite pattern type, which of a plurality of pattern types corresponding to the composite pattern type the operation information corresponds to is determined to determine the second pattern type, thereby making it possible to sequentially determine the pattern types corresponding to the operation information.

Here, since the second pattern type is determined as a specific pattern type among the plurality of pattern types belonging to the first pattern type after the first pattern type is determined, the second pattern type becomes a pattern type belonging to the determined first pattern type.

A high-level view of a relationship between MPEG-U and MPEG-V is shown in FIG. 3.

The advanced user interaction interface device according to the exemplary embodiment of the present invention includes an input device 310, a user interface unit 320, and a creator 330.

The input device 310 recognizes operation information of a user. The input device 310 may recognize touch information of the user by a physical contact with the user or may be a motion sensor, a camera, or the like, recognizing a static pose, a dynamic motion, or the like, of the user without physically contacting the user.

The user interface unit 320 determines information of a pattern type corresponding to the above-mentioned operation information in a basic pattern type and a composite pattern type and converts the operation information into the information of the pattern type to transfer the information of the pattern type to the creator 330.

The basic pattern type may include at least any one of the geometric interactivity pattern type, the symbolic pattern type, the touch pattern type, the hand posture pattern type, and the hand gesture pattern type as described above, and the composite pattern type may be a pattern type in which at least two of the basic pattern types are combined with each other.

Here, the user interface unit 320 may provide attribute information (sameObject) indicating whether or not the composite pattern type is a composite type created by the same object. Therefore, in the case in which the operation information of the user corresponds to the composite pattern type, the converted information of the pattern type becomes different according to whether or not the operation information is a pattern type formed by the same object, that is, the same hand.

The user interface unit 320 may include an interpreter 321 and an interface 322.

The interpreter 321 creates semantics corresponding to the basic pattern type and the composite pattern type. A process of recognizing the operation information of the user to create the semantics is the same as the process described above in the advanced user interaction interface method.

The interface 322 determines and transfers the pattern type corresponding to the operation information in the basic pattern type and the composite pattern type. A single interface 322 or a plurality of interfaces 322 may be provided.

The creator 330 may receive the information of the pattern type corresponding to the operation information to create indication information for performing a command corresponding to the operation information.

An operator (not shown) receives the indication information created in the creator 330 to perform the command corresponding to the operation information. In order words, when the user performs a V shaped touch operation on the input device, the user interface unit 320 recognizes the V shaped touch operation as a V shaped symbolic pattern type to convert the operation information into the information of the pattern type corresponding to a V shape, and when the creator 330 creates the indication information corresponding to the converted information to transmit the indication information to the operator, the operator performs the command corresponding to the indication information.

Meanwhile, the user interface unit 320 may further includes a converter 323. The converter 323 may receive the information of the pattern type corresponding to the operation information from the interface 322 and convert the information of the pattern type into widget data to transfer the converted widget data to the a widget creator.

Hereinabove, although the embodiments of the present invention have been described in detail, the scope of the present invention is not limited thereto, but modifications and alterations made by those skilled in the art using the basic concept of the present invention defined in the following claims fall within the scope of the present invention

1. An advanced user interaction interface method, comprising:
determining a pattern type corresponding to a physical information inputted from an object in a basic pattern type and a composite pattern type,
wherein the composite pattern type is a combination of at least two pattern types of the basic pattern type, and
wherein the basic pattern type includes at least one of a geometric interactivity pattern type, a symbolic pattern type, a symbolic touch pattern type, a hand posture pattern type, and a hand gesture pattern type.

2. The advanced user interaction interface method of claim 1, wherein the composite pattern type includes attribute information indicating whether or not it is created by the same object.

3. The advanced user interaction interface method of claim 1, wherein the geometric interactivity pattern type represents the physical information inputted from the object as two-dimensional (2D) or three-dimensional (3D) position information to recognize the physical information as a 2D or 3D geometry, and provides a predetermined number of base geometries as base geometric patterns and combines the base geometric patterns with each other to represent the physical information of the object.

4. The advanced user interaction interface method of claim 3, wherein in representing the base geometric pattern, static information stopped in view of a time is described in an element, and dynamic information in view of the time is added as an option to an attribute to separately represent the static information and the dynamic information.

5. The advanced user interaction interface method of claim 1, wherein the symbolic pattern type recognizes the physical information as a symbol based on a size and a position of the physical information.

6. The advanced user interaction interface method of claim 1, wherein the symbolic touch pattern types recognizes the physical information as a symbolic touch pattern based on an input continuance time, the number of inputs, an input movement direction, and a rotation direction of the physical information.

7. The advanced user interaction interface method of claim 1, wherein the hand posture pattern type recognizes operation information inputted from the object as a new hand posture based on an input user's hand posture or user's position.

8. The advanced user interaction interface method of claim 1, wherein the hand gesture pattern type recognizes dynamic operation information inputted from the object as a hand gesture based on the operation information.

9. The advanced user interaction interface method of claim 1, wherein the geometric interactivity pattern type includes at least one of additional information of a point type, a line type, a rectangle type, an arc type and a circle type respectively.

10. The advanced user interaction interface method of claim 9, wherein the additional information of the point type includes a coordinate, the additional information of the line type includes at least one of a starting point coordinate, an ending point coordinate, a starting point timestamp, an average velocity, and a maximum acceleration, the additional information of the rectangle type includes at least one of coordinates of diagonally positioned two corners and a timestamp when four corners are recognized, the additional information of the arc type includes at least one of coordinates corresponding to one end and the other end of an arc, a coordinate corresponding to the center of the arc, and an angular velocity, an angular acceleration, and a timestamp for a starting point of the arc, and the additional information of the circle type includes at least one of a coordinate of the center of a circle and a size of a radius of the circle.

11. The advanced user interaction interface method of claim 9, wherein at least one of the pattern type and the additional information is provided to an application and the application performs a command corresponding to operation information inputted from the object using at least one of the provided pattern type or additional information.

12. The advanced user interaction interface method of claim 1, wherein the determining of the pattern type corresponding to the physical information inputted from the object in the basic pattern type and the composite pattern type includes:
determining that one of the basic pattern type and the composite pattern type is a first pattern type; and
determining that one specific pattern type corresponding to operation information, which is the physical information inputted from the object, among pattern types belonging to the basic pattern type and the composite pattern type is a second pattern type,
wherein the second pattern type belongs to the determined first pattern type.

13. The advanced user interaction interface method of claim 1, further comprising receiving the physical information of the object.

14. An advanced user interaction interface method, comprising:
determining a pattern type corresponding to physical information inputted from an object in a basic pattern type and a composite pattern type; and
determining whether the physical information is a composite pattern type created by the same object in the case in which the physical information corresponds to the composite pattern type.

15. An advanced user interaction interface apparatus, comprising:
a user interface unit providing information of a pattern type corresponding to physical information inputted from an object in a basic pattern type and a composite pattern type,
wherein the composite pattern type is a combination of at least two pattern types of the basic pattern type, and
wherein the basic pattern type includes at least one of a geometric interactivity pattern type, a symbolic pattern type, a touch pattern type, a hand posture pattern type, and a hand gesture pattern type.

16. The advanced user interaction interface apparatus of claim 15, wherein the composite pattern type includes attribute information indicating whether or not it is created by the same object.

17. The advanced user interaction interface apparatus of claim 15, wherein the user interface unit includes:
an interpreter creating semantics corresponding to the basic pattern type and the composite pattern type; and
an interface determining and transferring the pattern type corresponding to the physical information inputted from the object in the basic pattern type and the composite pattern type.

18. The advanced user interaction interface apparatus of claim 17, wherein the user interface unit further includes a converter receiving information from the interface to convert the physical information into information of the pattern type corresponding to the physical information.

19. The advanced user interaction interface apparatus of claim 15, further comprising:
an input device recognizing physical information of a user; and
a creator receiving the information of the pattern type to create indication information for performing a command corresponding to the physical information inputted from the object.

20. The advanced user interaction interface apparatus of claim 19, further comprising an operator receiving the indication information to perform the command corresponding to the physical information.
